(19) United States
(12) Patent Application Publication
(10) Pub. No.: US 2026/0133902 A1
(43) Pub. Date: May 14, 2026

(54) DYNAMIC MEMORY ALLOCATION FOR SQL SERVERS

(71) Applicant: RELATIVITY ODA LLC, Chicago, IL (US)

(72) Inventors: Kent Salsbery, Chicago, IL (US); Scott R. Ellis, Chicago, IL (US)

(21) Appl. No.: 19/387,348

(22) Filed: Nov. 12, 2025

Related U.S. Application Data
(60) Provisional application No. 63/720,089, filed on Nov. 13, 2024.

(51) Int. Cl. G06F 12/02; G06F 16/21

(52) U.S. Cl. CPC G06F 12/0238; G06F 16/21

(57) ABSTRACT

Techniques for dynamically allocating RAM among a plurality of SQL server instances are provided. A method includes analyzing, for a first SQL server instance of the plurality of SQL server instances, one or more first instance performance metrics; and responsive to determining, based upon the analysis of the one or more first instance performance metrics, that the first SQL server instance requires additional RAM: determine, based upon the analysis of the one or more first instance performance metrics, a first amount of RAM required by the first SQL server instance, and responsive to determining that the first amount of RAM is available in a memory pool, allocate the first amount of RAM for the first SQL server instance from the memory pool.

### CROSS-REFERENCE TO RELATED APPLICATIONS

This application claims priority to U.S. Patent Application No. 63/720,089, entitled “Dynamic Memory Allocation for SQL Servers” (filed Nov. 13, 2024), the entire contents of which are hereby incorporated by reference.

### FIELD OF THE DISCLOSURE

The present disclosure relates generally to computer-implemented methods and systems for managing resources in database servers, and more particularly, to dynamically allocating random access memory (RAM) among multiple SQL server instances based on performance metrics, such as analyzing instance and system performance metrics to improve RAM allocation.

### BACKGROUND

In the realm of computing, efficient management of memory resources is a perennial concern, especially for systems that handle large databases or are involved in data-intensive operations. Conventional systems often rely on static memory allocation strategies, where the allocation of random access memory (RAM) is predetermined and remains fixed during operation. This approach may lead to underutilization of memory resources in some scenarios and overutilization in others, potentially resulting in system performance degradation, increased latency, or even system failures. Furthermore, traditional methods often lack the flexibility to adapt to varying workloads or to optimize memory allocation dynamically based on real-time performance metrics.

In view of the foregoing challenges, there is a need for improved systems and methods for allocating memory to database servers.

### BRIEF SUMMARY

The following relates to systems and methods designed to dynamically allocate memory to a plurality of database server instances. The present techniques provide a comprehensive approach to dynamically allocating random access memory (RAM) among multiple SQL server instances running on a database server. This approach is designed to optimize the performance of both the SQL server instances and the operating system of the database server by ensuring efficient use of available RAM. The techniques involve analyzing performance metrics for individual SQL server instances and the operating system, determining RAM requirements based on these metrics, and reallocating RAM from a memory pool as necessary.

One of the significant improvements introduced by the present techniques is the enhancement of processing efficiency. By analyzing specific performance metrics, such as page life expectancy for SQL server instances and central processing unit (CPU) usage for the operating system, the techniques enable the identification of RAM requirements in real-time. This proactive approach allows for the timely allocation of RAM to instances or the operating system that are under stress, thereby preventing performance bottlenecks and ensuring smoother operation of the database server.

Furthermore, the present techniques contribute to better memory usage. Through the dynamic reallocation of RAM based on current performance metrics, the techniques ensure that RAM is not wasted on instances that do not require it at the moment. Instead, RAM is allocated to instances or the operating system that currently need additional resources. This approach maximizes the utilization of available RAM, reducing the likelihood of unnecessary RAM upgrades and contributing to cost savings.

The memory management server plays a crucial role in implementing these techniques. It includes a metrics collection module for retrieving performance metrics, a performance monitor module for analyzing these metrics and determining RAM requirements, and a RAM allocation module for reallocating RAM accordingly. The management interface module facilitates the review and manual control of performance metrics and RAM allocations. This comprehensive system ensures that RAM is allocated efficiently and effectively, addressing the needs of both SQL server instances and the operating system in a dynamic and responsive manner.

In one aspect, a computer-implemented method for dynamically allocating random access memory (RAM) among a plurality of SQL server instances running on a database server includes: (1) analyzing, by one or more processors for a first SQL server instance of the plurality of SQL server instances, one or more first instance performance metrics; and (2) responsive to determining, by the one or more processors based upon the analysis of the one or more first instance performance metrics, that the first SQL server instance requires additional RAM: (a) determine, by the one or more processors based upon the analysis of the one or more first instance performance metrics, a first amount of RAM required by the first SQL server instance, and (b) responsive to determining, by the one or more processors, that the first amount of RAM is available in a memory pool, allocate, by the one or more processors, the first amount of RAM for the first SQL server instance from the memory pool.

In another aspect, a system for dynamically allocating random access memory (RAM) among a plurality of SQL server instances running on a database server includes: (1) one or more processors; and (2) one or more non-transitory memories coupled to the one or more processors and storing instructions that when executed by the one or more processors, cause the one or more processors to: (a) analyze, for a first SQL server instance, one or more first instance performance metrics, and (b) responsive to determining, based upon the analysis of the one or more first instance performance metrics, that the first SQL server instance requires additional RAM: (i) determine, based upon the analysis of the one or more first instance performance metrics, a first amount of RAM required by the first SQL server instance, and (ii) responsive to determining, by the one or more processors, that the first amount of RAM is available in a memory pool, allocate the first amount of RAM for the first SQL server instance from the memory pool.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Additional, alternate and/or fewer actions, steps, features and/or functionality may be included in an aspect and/or embodiments, including those described elsewhere herein. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. There are shown in the figures arrangements which are presently discussed; it being understood, however, that the present embodiments are not limited to the precise arrangements and instrumentalities shown.

FIG. 1 illustrates an example computer environment that may be used to implement the techniques for dynamic memory allocation, according to an embodiment.

FIG. 2 illustrates an example computer system that may be used to implement the techniques for dynamic memory allocation, according to an embodiment.

FIGS. 3A and 3B illustrate exemplary memory allocations, according to an embodiment.

FIG. 4 illustrates an example flow diagram for dynamic memory allocation, according to an embodiment.

FIG. 5 illustrates an example proportional-integral-derivative (PID) controller that may be used to implement the techniques for dynamic memory allocation, according to an embodiment.

FIG. 6 illustrates an example of training and validating a machine learning (ML) regression model, according to an embodiment.

FIG. 7 illustrates an example ML regression model that may be used to implement the techniques for dynamic memory allocation, according to an embodiment.

FIG. 8 illustrates an example computer-implemented method for dynamic memory allocation, according to an embodiment.

### DETAILED DESCRIPTION

### I. Example Computing Environment and Computer System

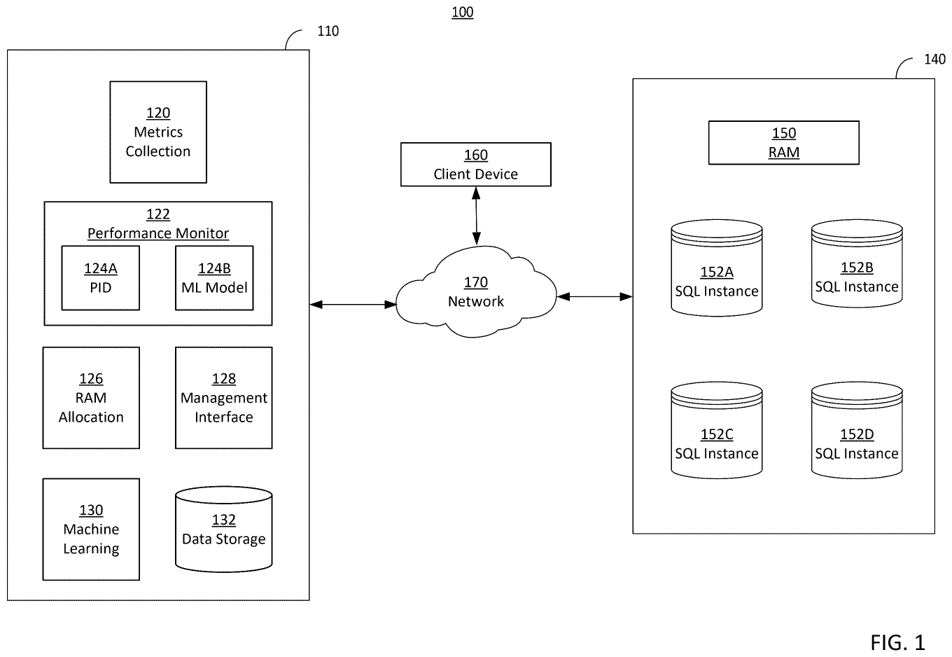

FIG. 1 illustrates an exemplary computer environment 100 for dynamically allocating memory among SQL server instances. The high-level architecture includes both hardware and software applications, as well as various data communications channels for communicating data between the various hardware and software components.

As illustrated, the computing environment 100 includes a memory management server 110, a database server 140, a client device 160, and a network 170. The memory management server 110 and/or the components thereof may be implemented as software modules within a cloud and/or distributed computing system (e.g., Amazon Web Services (AWS) or Microsoft Azure). In some embodiments, the memory management server 110 includes multiple instances of the same component to increase the ability the parallelization for the various functions performed via the respective components. In some embodiments, one or more elements of the memory management server 110 and/or the database server 140 may embodied by one or more virtual machines.

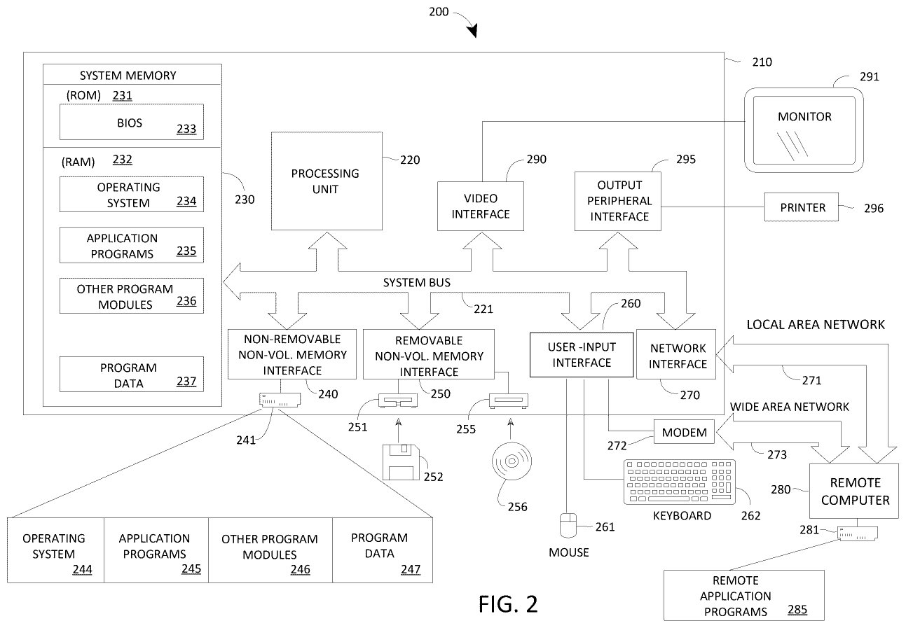

To implement the computing environment 100, a computing system may be used, such as computing system 200 of the example of FIG. 2 to host and/or execute at least a portion of the memory management server 110 and/or database server 140. The computing system 200 may include a computer 210. Components of the computer 210 may include, but are not limited to, a processing unit 220, a system memory 230, and a system bus 221 that couples various system components including the system memory 230 to the processing unit 220. In some embodiments, the processing unit 220 may include one or more parallel processing units capable of processing data in parallel with one another. The system bus 221 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 210 may include a variety of computer-readable media. Computer-readable media may be any available media that can be accessed by computer 210 and may include both volatile and nonvolatile media, and both removable and non-removable media. By way of example, and not limitation, computer-readable media may comprise computer storage media and communication media. Computer storage media may include volatile and nonvolatile, removable and non-removable media implemented in any method or technology for storage of information such as computer-readable instructions, data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 210.

Communication media typically embodies computer-readable instructions, data structures, program modules or other data in a modulated data signal such as a carrier wave or other transport mechanism, and may include any information delivery media. The term “modulated data signal” means a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared and other wireless media. Combinations of any of the above are also included within the scope of computer-readable media.

The system memory 230 may include computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to, and/or presently being operated on, by processing unit 220. By way of example, and not limitation, FIG. 2 illustrates operating system 234, application programs 235, other program modules 236, and program data 237. For example, the application programs 235, the program modules 236, and/or the program data 237 may include any of the applications executed within the memory management server 110.

The computer 210 may also include other removable/non-removable, volatile/nonvolatile computer storage media. By way of example only, FIG. 2 illustrates a hard disk drive 241 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 may be connected to the system bus 221 through a non-removable memory interface such as interface 240, and magnetic disk drive 251 and optical disk drive 255 may be connected to the system bus 221 by a removable memory interface, such as interface 250.

The drives and their associated computer storage media discussed above and illustrated in FIG. 2 provide storage of computer-readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as cursor control device 261 (e.g., a mouse, trackball, touch pad, etc.) and keyboard 262. A monitor 291 or other type of display device is also connected to the system bus 221 via an interface, such as a video interface 290. In addition to the monitor, computers may also include other peripheral output devices such as printer 296, which may be connected through an output peripheral interface 295.

The computer 210 may operate in a networked environment using logical connections to one or more remote computers, such as a remote computer 280. The remote computer 280 may be a personal computer, a server, a router, a network PC, a peer device or other common network node, and may include many or all of the elements described above relative to the computer 210, although only a memory storage device 281 has been illustrated in FIG. 2. The logical connections depicted in FIG. 2 include a local area network (LAN) 271 and a wide area network (WAN) 273 but may also include other networks. Such networking environments are commonplace in offices, enterprise-wide computer networks, intranets, and the Internet.

When used in a LAN networking environment, the computer 210 is connected to the LAN 271 through a network interface 270. When used in a WAN networking environment, the computer 210 may include a modem 272 or other means for establishing communications over the WAN 273, such as the Internet. The modem 272, which may be internal or external, may be connected to the system bus 221 via the input interface 260, or other appropriate mechanism. The communications connections (network interface 270 and/or modem 272), which allow the device to communicate with other devices, are an example of communication media, as discussed above. In a networked environment, program modules depicted relative to the computer 210, or portions thereof, may be stored in the remote memory storage device 281. By way of example and not limitation, FIG. 2 illustrates remote application programs 285 as residing on memory device 281.

In some embodiments, the computing system 200 is a server computing system communicatively coupled to a local workstation (e.g., a remote computer 280) via which a user interfaces with the computing the computing system 200. For example, the computer 210 may be configured to present one or more user interfaces at a local workstation (e.g., a client device) for presentation thereat to receive descriptions of the classification model and/or to present outputs of the prompt-based classification model.

In some embodiments, the computing system 200 may include any number of computers 210 configured in a cloud or distributed computing arrangement. Accordingly, the computing system 200 may include a cloud computing manager system (not depicted) that efficiently distributes the performance of the functions described herein between the computers 210 based on, for example, a resource availability of the respective processing units 220 or system memories 230 of the computers 210. In these embodiments, the data associated with performance of a database server and/or database instances may be stored in a cloud or distributed storage system (not depicted) accessible via the local area network 271 or the wide area network 273. Accordingly, the computer 210 may communicate with the cloud storage system to access the performance data when determining memory allocation.

As illustrated in FIG. 1, the database server 140 includes RAM 150 and a plurality of SQL instances 152A-152D. Although four SQL instances are depicted in FIG. 1, a different number of database instances may be implemented. The RAM 150 may store an operating system (OS) (e.g., Microsoft Windows, Linux, UNIX, MacOS, etc.) capable of facilitating the SQL instances 152A-152D. The RAM 150 is shared among the operating system (not depicted) and the SQL instances 152A-152D. In some embodiments, the memory management server 110 and database server 140 are implemented together on a single physical or virtual machine.

The client device 160 may be any suitable computing device operated by a user to interface with the memory management server 110 and/or database server 140. For example, the client device 160 may include one or more servers, personal computers, smartphones, tablets, etc.

The memory management server 110 includes various modules that can be executed by the memory management server 110, each module being a respective set of computer-executable instructions. The modules may comprise machine code, assembly code, byte code, and/or interpreted code. The modules may be written in Python, C++, JavaScript, or any other suitable programming language. In some embodiments, the memory management server 110 may include a metrics collection module 120, a performance monitor module 122, a RAM allocation module 126, a management interface module 128, and an ML module 130. In operation, the modules executing within the memory management server 110 may be configured to facilitate dynamic memory allocation on the database server 140.

The metrics collection module 120 supports operations for periodically or continuously retrieving performance metrics from an operating system and one or more SQL server instances of the database server 140. For example, the operating system performance metrics may include CPU usage, memory usage, disk input/output operations, disk queue length, memory pages per second, latch wait time, and any other suitable metrics. The SQL server instance performance metrics may include batch requests per second, SQL compilations per second, last elapsed time, buffer cache hit ratio, checkpoint pages per second, page life expectancy, average wait lock time, lock waits per second, and any other suitable metrics. In some embodiments, the metrics collection module 120 uses application programming interfaces (API) on the database server 140 to retrieve the performance metrics. In some embodiments, the metrics collection module 120 is configured to connect to the database server 140 and execute one or more commands to retrieve the performance metrics. In some embodiments, the database server 140 includes one or more software agents that push the performance metrics to the metrics collection module 120.

The performance monitor module 122 analyzes the performance metrics and determines or predicts whether the database server 140 or SQL server instances 152A-152D are having or will have performance issues and thus require memory reallocation. In some embodiments, the performance monitor module 122 determines whether one or more performance metrics for the database server operating system and/or a given database instance falls outside of a predefined target window. In some embodiments, performance monitor module 122 includes a proportional-integral-derivative (PID) controller 124A to determine RAM requirements in response to one or more performance metrics. In some embodiments, the performance monitor module 122 includes an ML regression model 124B to predict future RAM requirements based on the performance metrics or rate of change of the performance metrics.

The RAM allocation module 126 allocates and/or reallocates RAM on the database server 140. The RAM allocation module 126 may use the determined or predicted RAM requirements from the performance monitor module 122 to determine the allocation of RAM among the operating system and SQL instances on the database server 140. In some embodiments, the RAM allocation module 126 transmits one or more commands to the database server 140 and/or database instances to configure a minimum and/or maximum RAM setting.

The management interface module 128 facilitates review and/or manual control of one or more performance metrics and RAM allocations. In some embodiments, the management interface module 128 may be configured to present one or more graphical user interface (GUIs) on the client device 160. Accordingly, the management interface module 128 and the client device 160 may be communicatively coupled via the network 170.

The ML module 130 may employ supervised, semi-supervised, and/or unsupervised learning to train the ML regression model 124B to predict future RAM requirements from a plurality of performance metrics. The ML module 130 may incorporate an ML library, such as TensorFlow, PyTorch, HuggingFace, and/or scikit-learn. In one embodiment, the ML module 130 trains the ML regression model 124B to identify patterns in existing data to make predictions about future RAM usage by one or more of the SQL server instances and/or operating system. Specifically, the ML module 130 “trains” the ML regression model 124B using training data, which may include example performance metrics and associated RAM requirements. Based upon the training data, the ML regression model 124B may generate a predictive function which maps outputs to inputs and may utilize the performance metrics to generate predicted RAM requirements based upon past and/or present performance metric inputs.

The memory management server 110 includes or has access to data storage 132. One or more of the software modules may store and/or retrieve information from the data storage 132. The data storage 132 may include a relational database, (such as Oracle, DB2, or MySQL), a NoSQL based database (such as MongoDB), a vector database (such as Pinecone or LlamaIndex), and/or a graph database (such as Neo4j or ArangoGraph). In some embodiments, the data storage 132 includes an observability table storing performance metrics. In some embodiments, the data storage 132 includes an activity log storing a history of RAM allocations and reallocations. In some embodiments, the data storage 132 includes ML training and/or validation data.

For example, the network 170 may include one or more wired and/or wireless local area networks (LANs) and/or one or more wired and/or wireless wide area networks (WANs), such as the Internet.

Furthermore, although the example computing environment 100 illustrates only one of each of the components, any number of the example components are contemplated (e.g., any number of computing devices, user devices, databases, etc.).

### II. Example RAM Allocations

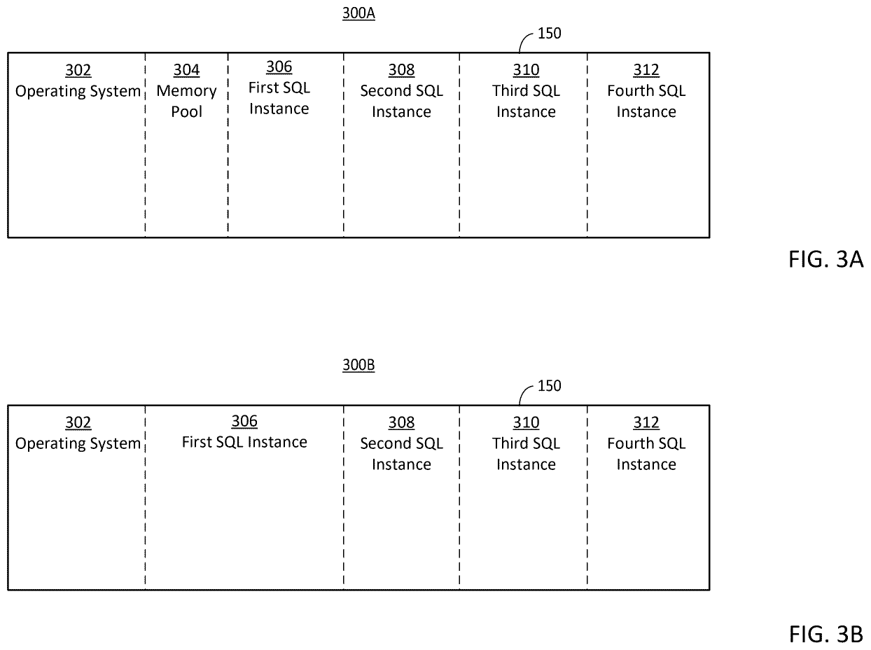

FIGS. 3A and 3B depict exemplary RAM allocations 300A and 300B, respectively, associated with dynamic memory management of the operating system and SQL server instances on the database server 140. The performance monitor module 122 and/or the RAM allocation module 126 may determine the RAM allocations 300A and 300B. The database server 140 includes a quantity of RAM 150. In one example, RAM 150 may include 64 GB of RAM; in other implementations, the quantity of RAM may be higher or lower.

RAM allocation 300A illustrates that RAM 150 is allocated among an operating system 302, a memory pool 304, a first SQL instance 306, a second SQL instance 308, a third SQL instance 310, and a fourth SQL instance 312. The RAM allocated to the operating system 302 is for the operating system and other program modules of the database server 140. The RAM allocated to the memory pool 304 is free RAM that the RAM allocation module 126 may allocate to the operating system 302 and/or SQL instances 306-312 as the performance monitor module 122 determines necessary. The RAM allocated to the SQL instances 306-312 is for SQL instances 152A-152D, respectively. For example, as illustrated in FIG. 3A, the RAM allocations for the first SQL instance 306, the second SQL instance 308, the third SQL instance 310, and the fourth SQL instance 312 are equal or approximately equal.

FIG. 3B illustrates RAM allocation 300B, in which RAM allocation module 126 has reallocated all of the RAM from the memory pool 304 into first SQL instance 306. The RAM allocation module 126 reallocates the RAM 150 when the performance monitor module 122 detects and/or predicts that any of the operating system 302 and/or the SQL instances 306-312 requires greater or lesser amounts of RAM.

### III. Example Dynamic Memory Allocation Flow Diagram

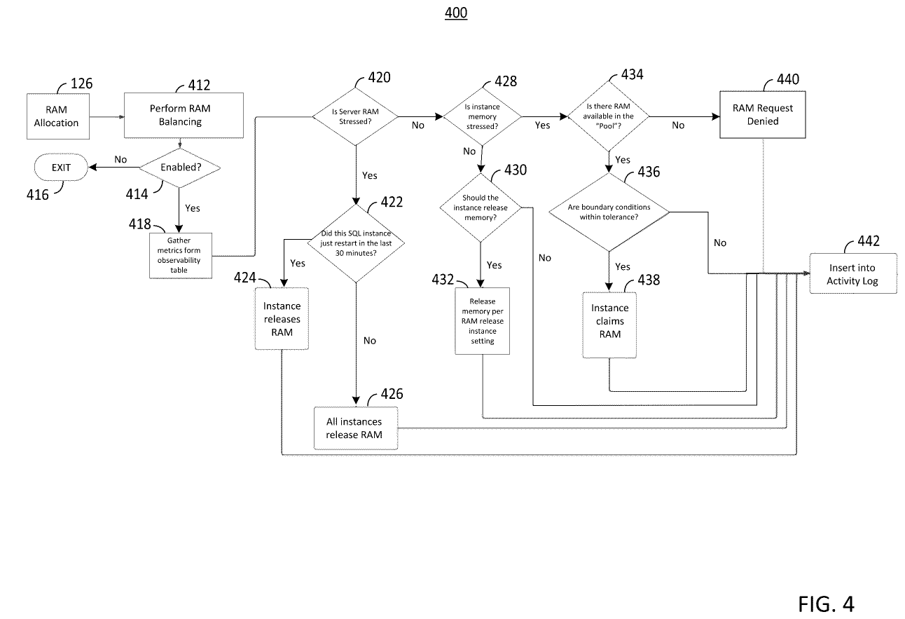

FIG. 4 depicts an example dynamic memory allocation flow diagram 400. The steps in the flow diagram 400 may be performed periodically, e.g., every 60 seconds.

In some embodiments, at step 412, the RAM allocation module 126 is activated to perform RAM allocation and reallocation. Activation may occur via startup of the memory management server 110 or on manual startup by an administrator. At step 414, the system checks if RAM balancing is enabled. For example, RAM balancing may be explicitly disabled by an administrator. If RAM balancing is not enabled, then the RAM allocation module 126 exits at step 416.

In some embodiments, the performance monitor module 122 gathers metrics from an observability table at step 418. The observability table includes performance metrics for the operating system and SQL server instances of the database server 140. The observability table may be stored in data storage 132 or another suitable location. The observability table may be periodically updated with the latest performance metrics.

In some embodiments, the performance monitor module 122 determines whether operating system RAM is stressed or predicts whether server RAM will become stressed at step 420. The performance monitor module 122 may analyze one or more operating system performance metrics from the observability table to determine whether the operating system RAM is stressed. If the server RAM is determined or predicted to be stressed, then at step 422 the RAM allocation module 126 determines which, if any, SQL server instances has restarted within a configurable time period, e.g., 30 minutes. If a SQL server instance has restarted within the time period, then the RAM allocation module 126 releases excess RAM from the restarted SQL server instance at step 424 and logs the activity at step 442. If no SQL server instance has restarted within the time period, then at step 426 the RAM allocation module 126 releases RAM from a plurality of SQL server instances and allocates some or all of the released RAM to the operating system until the operating system RAM is no longer stressed and logs the activity at step 442.

In some embodiments, if the operating system RAM is not stressed at step 420, then the performance monitor module 122 determines or predicts for a plurality of SQL server instances whether the SQL server instance is or will become stressed at step 428. The performance monitor module 122 may analyze one or more SQL server performance metrics from the observability table to determine whether the SQL server instance RAM is stressed. If the SQL server instance RAM is determined or predicted not to be stressed, then the performance monitor module 122 determines whether the SQL server instance should release RAM at step 430. The performance monitor module 122 may analyze one or more SQL server performance metrics from the observability table to determine whether the SQL server instance should release RAM. If the performance monitor module 122 determines that the instance should not release RAM, then that determination is logged in the activity log at step 442. If the performance monitor module 122 determines that the instance should release RAM, then the RAM allocation module 126 releases RAM from that SQL server instance at step 432 and logs the activity at step 442.

If the performance monitor module 122 determines that the SQL server instance RAM is stressed at step 428, then at step 434 the RAM allocation module 126 determines whether there is RAM available in the memory pool. If no RAM is available in the memory pool, then RAM allocation module 126 denies the RAM request at step 440 and logs the activity in the activity log at step 442. If RAM is available in the memory pool, then the RAM allocation module 126 determines whether boundary conditions are within tolerance at step 436. The boundary conditions may include a maximum RAM allocation and a minimum RAM allocation per SQL server instance. If the boundary conditions are not satisfied, then the event is logged into the activity log at step 442. If the boundary conditions are satisfied, then RAM in the memory pool is reallocated to the SQL server instance at step 438, and the activity is logged at step 442.

### IV. Example PID Controller for Dynamic Memory Allocation

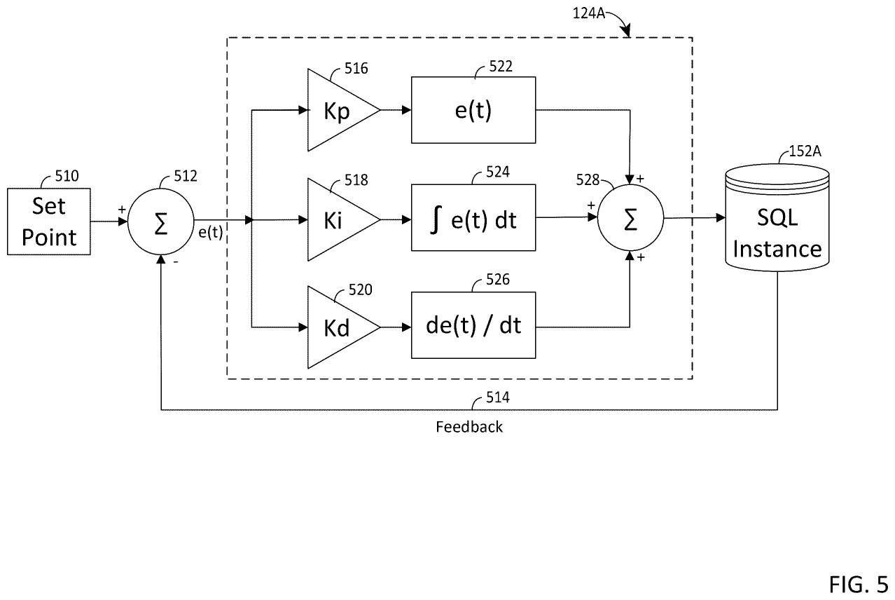

FIG. 5 depicts an example PID controller 124A in a closed loop control system for dynamically managing the memory allocated to a SQL server instance or the memory allocated to the server operating system. In some embodiments, the PID controller 124A receives as input one or more performance metrics, such as page life expectancy, that may indicate the SQL server instance may be stressed due to lack of RAM. In some embodiments, the PID controller 124A receives as input one or more performance metrics, such as CPU usage, that may indicate the operating system may be stressed due to lack of RAM. In some embodiments, the PID controller 124A outputs one or more settings, such as maximum server memory, for the SQL server instance in response to the performance metric input. In some embodiments, the PID controller 124A comprises a proportional (P) controller or a proportional-integral (PI) controller. In alternative embodiments, the PID controller 124A includes more and/or different inputs and outputs than those shown in FIG. 5.

In one embodiment, an administrator configures a set point 510, i.e., a target value, for one or more of the performance metrics. For example, the set point 510 may be a page life expectancy of 300 seconds or a CPU usage of 75%. At summation element 512, the feedback 514 may be subtracted from the set point 510 to generate the error, e(t). The feedback 514 may be the most recent measurement of the performance metric. For example, if the feedback 514 is a page life expectancy of 200 seconds, and the set point 510 is a page life expectancy of 300 seconds, then e(t) would be 100 seconds.

In one embodiment, the PID controller 124A includes a proportional controller 522. The proportional controller 522 multiplies e(t) by a proportional constant (Kp) 516 to generate a proportional output, P=Kp*e(t). Thus, the output of proportional controller 522 varies linearly with e(t). The administrator may adjust the value of the proportional constant 516 to tune the magnitude of the proportional output for one or more of the SQL server instances or the operating system.

In some embodiments, the PID controller 124A includes an integral controller 524. The integral controller 524 may decrease or eliminate any steady state error remaining from the proportional controller 522. The integral controller 524 maintains a running sum of the error e(t) over time and multiplies it by the integral constant (Ki) 518 to generate an integral output I=Ki∫e(t)dt. The administrator may adjust the value of the integral constant 518 to tune the magnitude of the integral output for one or more of the SQL server instances or operating system.

In some embodiments, the PID controller 124A includes a derivative controller 526. The derivative controller 526 may act to dampen the output of the integral controller 524 to reduce any overshoot and/or oscillation around the set point 510. The derivative controller computes the slope of the error term and multiplies it by the derivative constant (Kd) 520 to generate a derivative output D=Kd*(d(e(t))/dt). The administrator may adjust the value of the derivative constant 520 to tune the magnitude of the derivative output for one or more of the SQL server instances or operating system.

In some embodiments, a summation element 528 adds the outputs of the proportional controller 522, the integral controller 524, and/or the derivative controller 526 to generate a controller output. The controller output may be used to set a new RAM allocation setting for the SQL server instance 152A or operating system. For example, the RAM allocation module 126 may execute the following command on the SQL server instance 152A to allocate 4 GB of RAM to that SQL server instance:

sp_configure ‘show advanced options', 1;
GO
RECONFIGURE;
GO
sp_configure ‘max server memory’, 4096;
GO
RECONFIGURE;
GO

### V. Example ML Regression Model Training and Validation

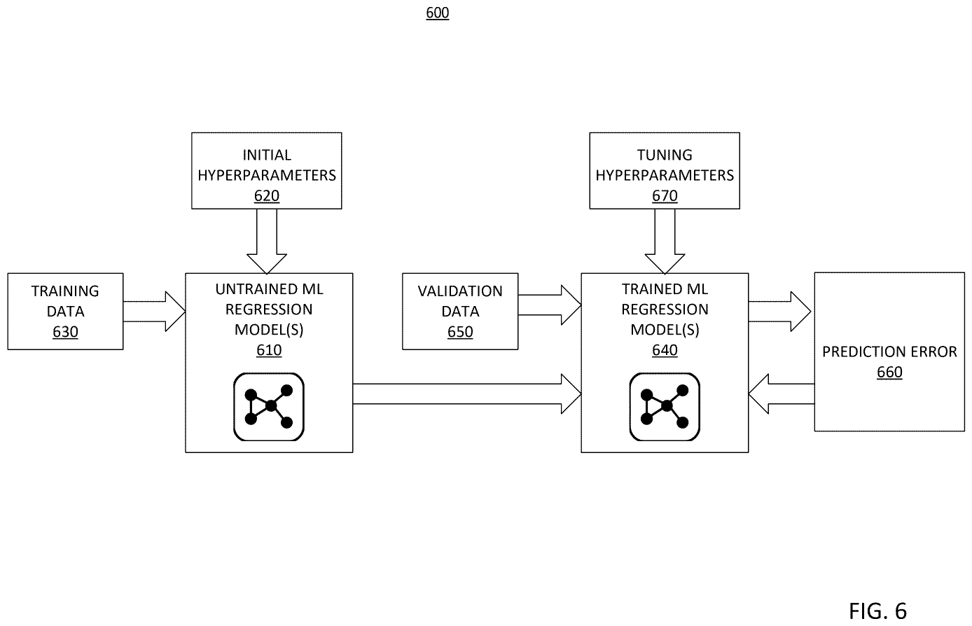

FIG. 6 illustrates an example ML environment 600 for ML training and validation. The ML module 130 any other suitable code or software may perform the ML training and validation.

In some embodiments, the ML module 130 may access data storage 132 or any other data source for data suitable to train and/or validate one or more ML regression models appropriate to receive and/or process SQL server instance performance data and/or operating system performance data and output a predicted future memory requirement. For example, the future memory requirement may predict the amount of RAM required 60 seconds, 120 seconds, or 300 seconds in the future. The SQL server instance performance data may be sample data from one or more operational SQL server instances used to fit the parameters (weights) of an ML regression model with the goal of training it by example. The operating system performance data may be sample data from one or more database server operating systems used to fit the parameters (weights) of an ML regression model with the goal of training it by example. The SQL server instance performance data and/or operating system performance data may be split into a training dataset 630 and a validation dataset 650. Alternatively, the training dataset 630 may comprise data from a plurality of SQL instances and database server operating systems, and the validation dataset 650 may comprise data from a single SQL instance or database server. Once an appropriate ML regression model is trained and validated to provide accurate memory utilization predictions, the trained ML regression model may be incorporated into the performance monitor module 122 as ML regression model 124B.

In some embodiments, there may be one or more untrained ML regression models 610. The one or more untrained ML regression models 610 may include one or more ML regression techniques, including linear, polynomial, support vector, decision tree, random forest, k-nearest neighbor (KNN), artificial neural network (ANN), and/or any other suitable regression techniques.

In some embodiments, the one or more untrained ML regression models 610 may be configured with a set of initial hyperparameters 620. For an ANN regression model, for example, the set of initial hyperparameters 620 may include specified values for the number of layers, layer size, activation function, learning rate, number of epochs, etc.

In some embodiments, one or more SQL server instance performance data collections and/or one or more operating system performance data collections may be split into a training dataset 630 and a validation dataset 650. The training dataset 630 and the validation dataset 650 may include performance data from one or more SQL server instances and/or one or more database server operating systems with known memory utilizations. The training dataset 630 and the validation dataset 650 may include a plurality of features, such as batch requests per second, SQL compilations per second, last elapsed time, buffer cache hit ratio, checkpoint pages per second, page life expectancy, average wait lock time, lock waits per second, and any other suitable SQL server instance features. The training dataset 630 and the validation dataset 650 may include a plurality of features, such as CPU usage, memory usage, disk input/output operations, disk queue length, memory pages per second, latch wait time, and any other suitable operating system features.

In some embodiments, the ML module 130 may retrieve the training dataset 630 from the data storage 132 and provide the training dataset 630 to the untrained ML regression model 610 in a training step. The training may cause a trained ML regression model 640 to be generated from the untrained ML regression model 610. The trained ML regression model 640 may include one or more regression modules that predict a future memory requirement based upon input data having a plurality of features. The trained ML regression model 640 may assign different parameters to different features such that some features are weighted more heavily than others.

In some embodiments, the ML module 130 may retrieve the validation dataset 650 from the data storage 132 and provide the validation dataset 650 to the trained ML regression model 640 in a validation step. The ML module 130 may withhold the known memory requirement values when providing the validation dataset 650 to the trained ML regression model 640. The validation may cause the trained ML regression model 640 to generate predicted memory requirements customized for a specific SQL server instance and/or specific database server operating system.

In some embodiments, the ML module 130 may calculate a prediction error 660 by comparing the predicted memory requirement value to the known memory requirement value. The ML module 130 may use the prediction error 660 to tune the trained ML regression model 640 by adjusting one or more parameters of the trained ML regression model 640 to minimize the prediction error 660.

In some embodiments, the trained ML regression model 640 may be tuned with a set of tuning hyperparameters 670. For an ANN model, for example, the set of tuning hyperparameters 670 may include specified values for number of layers, layer size, activation function, learning rate, number of epochs, etc.

### VI. Example ML Regression Model for Dynamic Memory Allocation

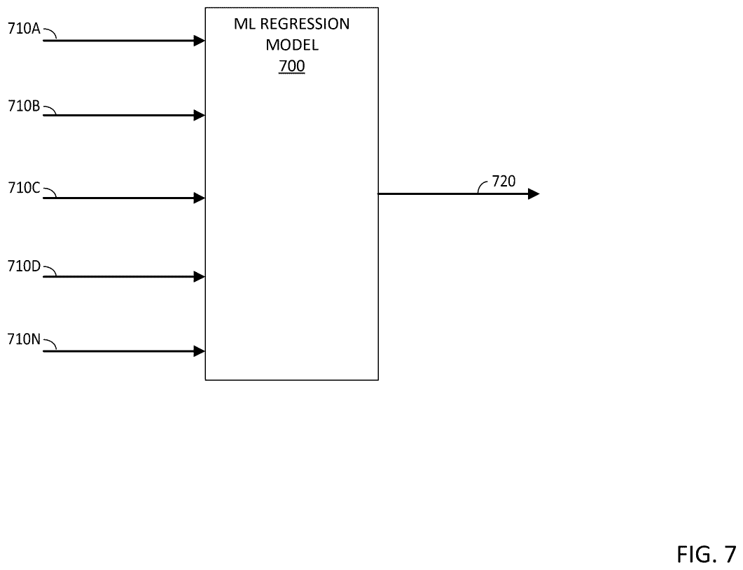

FIG. 7 depicts a diagram of an example ML regression model 700 for dynamic memory allocation. The ML regression model 700 may comprise the ML regression model 124B or the trained ML regression model 640.

The ML regression model 700 receives a plurality of inputs 710A-710N. Although five inputs 710A-710N are illustrated in FIG. 7, additional or fewer inputs may be received. In some embodiments, the plurality of inputs 710A-710N are collected by the metrics collection module 120, stored in the data storage 132, and provided to the ML regression model 700 by the performance monitor module 122. In some embodiments, the plurality of inputs 710A-710N include SQL server instance performance metrics, such as batch requests per second, SQL compilations per second, last elapsed time, buffer cache hit ratio, checkpoint pages per second, page life expectancy, average wait lock time, lock waits per second, running averages of any performance metrics, and/or rates of change of any performance metrics. In some embodiments, the plurality of inputs 710A-710N include database server operating system performance metrics, such as CPU usage, memory usage, disk input/output operations, disk queue length, memory pages per second, latch wait time, running averages of any operating system performance metrics, and/or rates of change of any operating system performance metrics.

The ML regression model 700 processes the plurality of inputs 710A-710N to generate an output 720. In some embodiments, the plurality of inputs 710A-710N are multiplied by weights and/or summed together by the ML regression model 700. In some embodiments, the ML regression model 700 processes the summed weighted inputs with a non-linear activation function. The output 720 may be a predicted future RAM requirement for a SQL server instance or the operating system of the database server. By predicting a future RAM requirement, the ML regression model 700 may identify upcoming RAM stress events before they occur. The RAM allocation module 126 may use the output 720 to allocate or reallocate RAM among the operating system and SQL server instances.

### VII. Example Method of Dynamic Memory Allocation

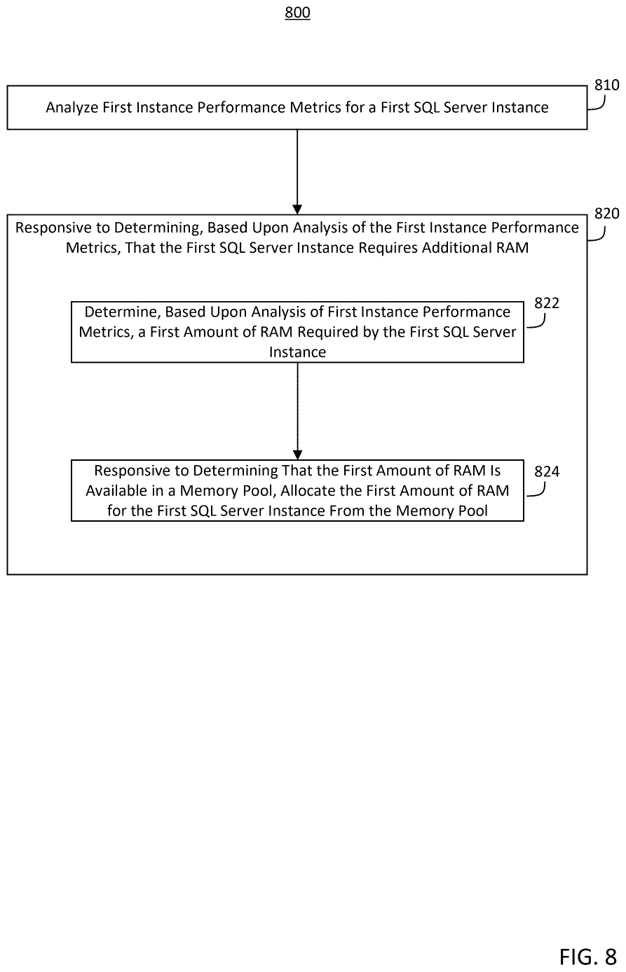

FIG. 8 depicts a flow diagram of an example computer-implemented method 800 for dynamic memory allocation. The method 800 may operate as a stand-alone method and/or may operate in conjunction with embodiments of at least a portion of the computer environment 100 and of any one or more components and/or devices related thereto, and/or with other systems, processors, databases and/or devices. For example, the memory management server 110, including one or more of the metrics collection module 120, performance monitor module 122, RAM allocation module 126, management interface module 128, and ML module 130 may execute at least a portion of the method 800. In some embodiments, the memory management server 110 may execute at least a portion of the method 800 in conjunction with one or more other components of the environment 100, such as the database server 140 and/or client device 160. Further, the method 800 may include additional or alternate steps other than those described with respect to FIG. 8 in embodiments.

At block 810, the one or more processors analyze first instance performance metrics for a first SQL server instance. The first instance performance metrics may include one or more of the following: batch requests per second, SQL compilations per second, last elapsed time, buffer cache hit ratio, checkpoint pages per second, page life expectancy, average wait lock time, lock waits per second, running averages of any performance metrics, and/or rates of change of any performance metrics. The first SQL server may be one of a plurality of SQL server instances running on the database server 140.

At block 820, responsive to determining, based upon an analysis of the first performance metrics by the one or more processors, that the first SQL server instance requires additional RAM, the one or more processors perform blocks 822 and 824.

At block 822, the one or more processors determine, based upon an analysis of first instance performance metrics, a first amount of RAM required by the first SQL server instance. In some embodiments, determining a first amount of RAM required by the first SQL server instance is performed by a proportional (P) controller, a proportional-integral (PI) controller, or a proportional-integral-derivative (PID) controller. In some embodiments, determining a first amount of RAM required by the first SQL server instance includes predicting by a trained ML regression the first amount of RAM required by the first SQL server instance.

At block 824, the one or more processors, responsive to determining that the first amount of RAM is available in a memory pool, allocate the first amount of RAM for the first SQL server instance from the memory pool. In some embodiments, allocating the first amount of RAM includes verifying that allocating the first amount of RAM will continue to satisfy a maximum RAM limit for the first SQL server instance. In some embodiments, allocating the first amount of RAM includes increasing a maximum server memory setting for the first SQL server instance by the first amount of RAM.

In some embodiments, the one or more processors analyze, for a second SQL server instance, one or more second SQL instance performance metrics. The second SQL server may be one of a plurality of SQL server instances running on the database server 140.

In some embodiments, responsive to determining, by the one or more processors from the analysis of the one or more second instance performance metrics, that the second SQL server instance has available RAM, the one or more processors release a second amount of RAM allocated for the SQL server instance into the memory pool. In some embodiments, releasing the second amount of RAM includes verifying that releasing the second amount of RAM will continue to satisfy a minimum RAM limit for the second SQL server instance. In some embodiments, releasing the second amount of RAM includes decreasing a maximum server memory setting by the second amount of RAM.

In some embodiments, the one or more processors analyze one or more system performance metrics for an operating system of the database server 140. The system performance metrics may include one or more of the following: CPU usage, memory usage, disk input/output operations, disk queue length, memory pages per second, latch wait time, running averages of any operating system performance metrics, and/or rates of change of any operating system performance metrics.

In some embodiments, responsive to determining, by the one or more processors based upon the analysis of the system performance metrics, that the operating system requires additional RAM, determine whether any of the plurality of SQL server instances had restarted within a specified time period. The specified time period may be 30 minutes, for example. In some embodiments, responsive to determining, by the one or more processors, that a third SQL server instance of the plurality of SQL server instances had restarted within the specified time period, release a third amount of RAM allocated for the third SQL server instance into the memory pool and allocate a fourth amount of RAM from the memory pool to the operating system. The third amount of RAM may be less than, greater than, or equal to the fourth amount of RAM. In some embodiments, responsive to determining, by the one or more processors, that no SQL server instance of the plurality of SQL server instances had restarted within the specified time period, the one or more processors release a fifth amount of RAM allocated for the first SQL server instance into the memory pool, release a sixth amount of RAM allocated for the third SQL server instance into the memory pool, and allocate a seventh amount of RAM from the memory pool to the database server. The fifth amount of RAM may be less than, greater than, or equal to the sixth amount of RAM. The seventh amount of RAM may be less than, greater than, or equal to the sum of the fifth and sixth amounts of RAM.

In some embodiments, responsive to determining, by the one or more processors, that the first amount of RAM is not available in the memory pool, the one or more processors transmit an alert to an administrator.

In some embodiments, the one or more processors generate, using training data, the trained ML regression model from an untrained ML regression model and validate, using validation data, the trained ML regression model. In some embodiments, the trained ML regression model is a linear, polynomial, support vector, decision tree, random forest, k-nearest neighbor (KNN), or artificial neural network (ANN).

It should be understood that not all blocks of the method 800 are required to be performed. Moreover, the method 800 is not mutually exclusive (i.e., block(s) from method 800 may be performed in any particular implementation).

### VIII. Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for practicing the techniques disclosed herein through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

Moreover, although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

1. A computer-implemented method for dynamically allocating random access memory (RAM) among a plurality of SQL server instances running on a database server, comprising:
analyzing, by one or more processors for a first SQL server instance of the plurality of SQL server instances, one or more first instance performance metrics; and
responsive to determining, by the one or more processors based upon analyzing the one or more first instance performance metrics, that the first SQL server instance requires additional RAM:
determine, by the one or more processors based upon analyzing the one or more first instance performance metrics, a first amount of RAM required by the first SQL server instance, and
responsive to determining, by the one or more processors, that the first amount of RAM is available in a memory pool, allocate, by the one or more processors, the first amount of RAM for the first SQL server instance from the memory pool.

2. The computer-implemented method of claim 1, further comprising:
analyzing, by the one or more processors for a second SQL server instance of the plurality of SQL server instances, one or more second instance performance metrics; and
responsive to determining, by the one or more processors from analyzing the one or more second instance performance metrics, that the second SQL server instance has available RAM:
release, by the one or more processors, a second amount of RAM allocated for the second SQL server instance into the memory pool.

3. The computer-implemented method of claim 1, further comprising:
analyzing, by the one or more processors, one or more system performance metrics for an operating system of the database server; and
responsive to determining, by the one or more processors based upon analyzing the system performance metrics, that the operating system requires additional RAM, determine whether any of the plurality of SQL server instances had restarted within a specified time period:
responsive to determining, by the one or more processors, that a third SQL server instance of the plurality of SQL server instances had restarted within the specified time period:
release a third amount of RAM allocated for the third SQL server instance into the memory pool, and
allocate a fourth amount of RAM from the memory pool to the operating system.

4. The computer-implemented method of claim 3, further comprising:
responsive to determining, by the one or more processors, that no SQL server instance of the plurality of SQL server instances had restarted within the specified time period:
release a fifth amount of RAM allocated for the first SQL server instance into the memory pool,
release a sixth amount of RAM allocated for the third SQL server instance into the memory pool, and
allocate a seventh amount of RAM from the memory pool to the database server.

5. The computer-implemented method of claim 1, wherein allocating the first amount of RAM comprises verifying that allocating the first amount of RAM will continue to satisfy a maximum RAM limit for the first SQL server instance.

6. The computer-implemented method of claim 2, wherein releasing the second amount of RAM comprises verifying that releasing the second amount of RAM will continue to satisfy a minimum RAM limit for the second SQL server instance.

7. The computer-implemented method of claim 1, wherein allocating the first amount of RAM comprises increasing a maximum server memory setting for the first SQL server instance by the first amount of RAM.

8. The computer-implemented method of claim 2, wherein releasing the second amount of RAM comprises decreasing a maximum server memory setting by the second amount of RAM.

9. The computer-implemented method of claim 1, further comprising:
responsive to determining, by the one or more processors, that the first amount of RAM is not available in the memory pool, transmit an alert to an administrator.

10. The computer-implemented method of claim 1, wherein the one or more first instance performance metrics comprise a page life expectancy metric.

11. The computer-implemented method of claim 3, wherein the one or more system performance metrics comprise a central processing unit (CPU) usage metric.

12. The computer-implemented method of claim 1, wherein determining the first amount of RAM required by the first SQL server instance is performed by a proportional controller.

13. The computer-implemented method of claim 11, wherein determining the first amount of RAM required by the first SQL server instance is performed by a proportional-integral controller.

14. The computer-implemented method of claim 12, wherein determining the first amount of RAM required by the first SQL server instance is performed by a proportional-integral-derivative controller.

15. The computer-implemented method of claim 1, wherein determining the first amount of RAM required by the first SQL server instance comprises predicting by a trained machine learning (ML) regression model the first amount of RAM required by the first SQL server instance.

16. The computer-implemented method of claim 15, further comprising:
generating, by the one or more processors using training data, the trained ML regression model from an untrained ML regression model; and
validating, by the one or more processors using validation data, the trained ML regression model.

17. The computer-implemented method of claim 15, wherein the trained ML regression model comprises an artificial neural network (ANN).

18. A system for dynamically allocating random access memory (RAM) among a plurality of SQL server instances running on a database server, comprising:
one or more processors; and
one or more non-transitory memories coupled to the one or more processors and storing instructions that when executed by the one or more processors, cause the one or more processors to:
analyze, for a first SQL server instance, one or more first instance performance metrics, and
responsive to determining, based upon analyzing the one or more first instance performance metrics, that the first SQL server instance requires additional RAM:
determine, based upon analyzing the one or more first instance performance metrics, a first amount of RAM required by the first SQL server instance, and
responsive to determining, by the one or more processors, that the first amount of RAM is available in a memory pool, allocate the first amount of RAM for the first SQL server instance from the memory pool.

19. The system of claim 18, wherein the instructions further cause the one or more processors to:
analyze, for a second SQL server instance, one or more second instance performance metrics, and
responsive to determining, from analyzing the one or more second instance performance metrics, that the second SQL server instance has available RAM:
release a second amount of RAM allocated for the second SQL server instance into the memory pool.

20.-22. (canceled)

23. The system of claim 19, wherein releasing the second amount of RAM comprises verifying that releasing the second amount of RAM will continue to satisfy a minimum RAM limit for the second SQL server instance.

24.-34. (canceled)
